(19) United States
(12) Patent Application Publication
(10) Pub. No.: US 2017/0052657 A1
(43) Pub. Date: Feb. 23, 2017

(54) DISPLAY METHOD AND APPARATUS

(71) Applicant: Samsung Electronics Co., Ltd., Suwon-si (KR)

(72) Inventors: Hyeeun LEE, Seoul (KR); Hyunjung KWON, Seoul (KR); Tae Eun KIM, Seoul (KR); Joonwon PARK, Yongin-si (KR); Jiyun LEE, Seongnam-si (KR)

(21) Appl. No.: 15/214,980

(22) Filed: Jul. 20, 2016

(30) Foreign Application Priority Data
Aug. 18, 2015 (KR) 10-2015-0115853

(51) Int. Cl. G06F 3/0482; G06F 3/0481

(52) U.S. Cl. CPC G06F 3/0482; G06F 3/04817

(57) ABSTRACT

A display method and an apparatus are provided. The display method includes the operations of executing a first item, identifying at least one second item associated with the first item, and displaying the at least one second item at a predetermined position on an execution screen of the first item.

### CROSS-REFERENCE TO RELATED APPLICATION(S)

This application claims the benefit under 35 U.S.C. §119(a) of a Korean patent application filed on Aug. 18, 2015 in the Korean Intellectual Property Office and assigned Serial number 10-2015-0115853, the entire disclosure of which is hereby incorporated by reference.

### TECHNICAL FIELD

The present disclosure relates to a display method and apparatus. More particularly, the present disclosure relates to a display method and apparatus, which can provide an icon relating to an item being executed, to a screen being executed.

### BACKGROUND

With the acceleration of the speed of electronic devices including smart phones, the electronic devices have come to have various functions. Especially, with the increase in the capacity of electronic device memories, items including various application programs, media files, and document files are increasing.

The electronic device provides a launcher program which enables a user to easily access the items. A launcher program is a program by which a user registers desired items in advance to execute the items. The launcher program refers to a software program which enables a user to, when accessing an item stored in an electronic device, previously register the item in the launcher program and then select the item in the launcher program, thereby decreasing the user's inconvenience in accessing the item.

The above information is presented as background information only to assist with an understanding of the present disclosure. No determination has been made, and no assertion is made, as to whether any of the above might be applicable as prior art with regard to the present disclosure.

### SUMMARY

The electronic device as described above can always provide only the items registered by a user in a launcher program regardless of the type of an item being executed. Therefore, the electronic device may be unable to provide an item having a high correlation with the item being executed.

Aspects of the present disclosure are to address at least the above-mentioned problems and/or disadvantages and to provide the advantages described below. Accordingly, an aspect of the present disclosure is to provide a display method and apparatus, which can provide an icon relating to an item being executed, to a screen being executed.

Another aspect of the present disclosure is to provide a second item, which a user has repeatedly executed at the time of executing a first item, as an item associated with the first item and provide the second item to a screen on which the first item is being executed.

Another aspect of the present disclosure is to provide a second item, which a user has selected at the time of executing a first item, as an item associated with the first item and provide the second item to a screen on which the first item is being executed.

In accordance with an aspect of the present disclosure, a display method is provided. The display method includes executing a first item, identifying at least one second item associated with the first item, and displaying the at least one second item on an execution screen of the first item.

In accordance with another aspect of the present disclosure, an electronic device is provided. The electronic device includes a memory configured to store a first item and at least one second items, and a controller configured to identify at least one second item associated with the first item and display the at least one second item on an execution screen of the first item.

A display method and apparatus of the present disclosure as described above configure at least one second item among at least one second item having a category associated with a first item being executed, a second item, which a user has repeatedly executed at the time of executing a first item, and a second item, which a user has selected at the time of executing a first item, as an item associated with the first item and provide the configured item to a screen on which the first item is being executed, thereby enabling the user to easily access the second item associated with the first item at the time of executing the first item.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a main configuration of an electronic device according to an embodiment of the present disclosure;

FIG. 2 is a flowchart for describing a display method according to an embodiment of the present disclosure;

FIG. 3 is a flowchart for describing a method of controlling execution of an item according to an embodiment of the present disclosure;

FIG. 4 is a flowchart for describing a method of controlling downloading of an item according to an embodiment of the present disclosure;

FIG. 5 is a flowchart for describing a method of controlling downloading of an item according to another embodiment of the present disclosure;

FIG. 6 illustrates an example of a screen for describing a method of displaying a second item on an execution screen of a first item associated with finance according to an embodiment of the present disclosure;

FIG. 7 illustrates an example of a screen for describing a method of displaying a second item on an execution screen of a first item associated with a web browser according to an embodiment of the present disclosure;

FIG. 8 illustrates an example of a screen for describing a method of displaying a second item on an execution screen of a first item associated with travel information according to an embodiment of the present disclosure;

FIG. 9 illustrates an example of a screen for describing a method of displaying a second item on an execution screen of a first item associated with a game according to an embodiment of the present disclosure;

FIG. 10 illustrates an example of a screen for describing a method of changing a position of a second item on an execution screen of a first item according to an embodiment of the present disclosure;

FIG. 11 illustrates an example of a screen for describing a method of recording an execution screen of a first item using a second item according to an embodiment of the present disclosure;

FIG. 12 illustrates an example of a screen for describing a method of contracting an execution screen of a first item using a second item according to an embodiment of the present disclosure;

FIG. 13 illustrates an example of a screen for describing a method of adding a web browser as a second item on an execution screen of a first item according to an embodiment of the present disclosure;

FIG. 14 illustrates an example of a screen for describing a method of adding another item as a second item on an execution screen of a first item according to an embodiment of the present disclosure;

FIG. 15 illustrates an example of a screen for describing a method of configuring a position of a second item on an execution screen of a first item according to an embodiment of the present disclosure;

FIG. 16 illustrates an example of a screen for describing a method of displaying a second item according to an embodiment of the present disclosure;

FIG. 17 illustrates an example of a screen for describing a method of displaying a second item according to another embodiment of the present disclosure; and

FIG. 18 illustrates an example of a screen for describing a method of displaying a second item according to still another embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

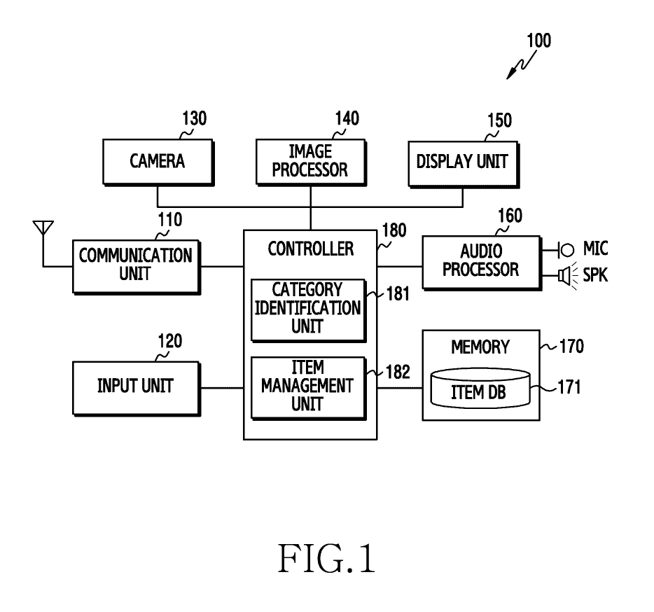

FIG. 1 is a block diagram illustrating a main configuration of an electronic device according to an embodiment of the present disclosure.

Referring to FIG. 1, the electronic device 100 according to an embodiment of the present disclosure may include a communication unit 110, an input unit 120, a camera 130, an image processor 140, a display unit 150, an audio processor 160, a memory 170, and a controller 180.

The communication unit 110 performs a communication in the electronic device 100. The communication unit 110 may communicate with an external device (not illustrated) in various communication schemes. Herein, the communication unit 110 can perform at least one of wireless communication and wired communication. To this end, the communication unit 110 may access at least one of a mobile communication network and a data communication network. Otherwise, the communication unit 110 can perform short-range communication. For example, the external device may include an electronic device, a base station, a server, and a satellite. The communication schemes may include long term evolution (LTE), wideband code division multiple access (WCDMA), global system for mobile communications (GSM), Wi-Fi, Bluetooth, and near field communication (NFC).

The input unit 120 generates input data in the electronic device. At this time, the input unit 120 may generate input data in response to a user input of the electronic device 100. The input unit 120 may include at least one input means. The input unit 120 may include a key pad, a dome switch, a physical button, a touch panel, a jog & shuttle, and a sensor.

The camera 130 generates image data. To this end, the camera 130 may receive an optical signal. Further, the camera 130 may generate image data from the optical signal. The camera 130 may include a camera sensor and a signal converter. The camera sensor may convert an optical signal to an electrical image signal. The signal converter may convert an analog image signal to digital image data.

The image processor 140 processes image data. The image processor 140 may process the image data in units of frames and output the image data in accordance with the characteristics and size of the display unit 150. The image processor 140 may compress image data according to a configured scheme or reconstruct compressed image data to original image data.

The display unit 150 outputs display data. For example, the display unit 150 may include a liquid crystal display (LCD), a light emitting diode (LED) display, an organic LED (OLED) display, a micro electro mechanical system (MEMS) display, and an electronic paper display. The display unit 150 may include a plurality of light emitting devices. Further, the display unit 150 may be combined with the input unit 120 to be implemented as a touch screen.

The audio processor 160 processes an audio signal. The audio processor 160 may include a speaker (SPK) and a microphone (MIC). That is, the audio processor 160 may reproduce the audio signal output from the controller 180 through the speaker. Further, the audio processor 160 may transfer an audio signal generated by the microphone to the controller 180.

The memory 170 stores operation programs of the electronic device 100. The memory 170 may store items including various application programs, media files, and document files. To this end, the memory 170 may include an item database (DB) 171.

By the control of the controller 180, the item DB 171 may store items according to categories as shown in Table 1 below. As noted from Table 1, each category may include at least one item, and a default item may be stored by default may be included in all categories. For example, the first item may be an item executed by the controller 180, for example, “bank A” in the category of “finance,” and the second item may be other items (i.e., housekeeping book, card B, or calculator) stored in the category of “finance,” which is the same category as that of “bank A.” Further, the second item may include “capture” stored as a default item in the category of “finance.”

TABLE 1

| | Category | | | |
|---|---|---|---|---|
| | Finance | News | Travel | Game |
| Item | Bank A | Newspaper | Airline F | Balloon |
| | | C | | bursting |
| | Housekeeping | Portal D | Hotel G | Figure |
| | book | | | stacking |
| | Card B | Magazine E | Travel agency H | Puzzle game |
| | Calculator | — | Travel agency I | — |
| Default | Capture | Capture | Capture | Capture |
| Item | | | | |

By the control of the controller 180, the item DB 171 may store second items associated with first items, as shown in Table 2 below. The second items may be items which can be displayed using icons on an execution screen of a first item. A second item may be an item having been executed a predetermined number of times or more by the user when a first item is executed, or an item having been added as a second item by a selection signal when a first item is executed.

TABLE 2

| | | | | |
|---|---|---|---|---|
| First | Bank A | Newspaper C | Travel | Balloon bursting |
| Item | | | agency H | |
| Second | Card B | Portal D | Calendar | Recording |
| Item | Housekeeping | Memo | Map | Game provider |
| | book | | | web site |
| | Calculator | Messenger | Calculator | Messenger |
| | — | — | Messenger | — |
| Default | Capture | Capture | Capture | Capture |
| Item | | | | |

The controller 180 controls a general operation of the electronic device 100. The controller 180 may perform various functions. To this end, the controller 180 may include a category identification unit 181 and an item management unit 182.

The category identification unit 181 may identify a category of a first item at the time of executing the first item. For example, when the first item being executed is “bank A,” the category identification unit 181 may identify, as second items, “housekeeping book, card B, and calculator” included in the “finance,” which is the category of “bank A” as in Table 1, and “capture” configured as a default item.

The item management unit 182 may identify at least one second item associated with the first item at the time of executing the first item. For example, when the first item being executed is “bank A,” the item management unit 182 may identify that the second items associated with “bank A” are “card B, housekeeping book, and calculator,” and may identify “capture” configured as a default item, as shown in Table 2.

The controller 180 may display icons of one or more second item among the second items identified by the category identification unit 181 or the second items identified by the item management unit 182 on a screen on which the first item is being executed.

The controller 180 may display a representative icon representing the second items on the screen on which the first item is being executed. When the representative icon is selected, the controller 180 may expand and display the icons of the second items. When a particular item is selected from the icons of the second items, the controller 180 may overlappingly display an execution screen of the selected icon on the screen on which the first item is being executed.

The controller 180 may change the location of the representative icon in response to an input received from the input unit 120. The controller 180 may contract and display the execution screen of the first item in response to an input received from the input unit 120. The controller 180 may contract or expand the execution screen of the second item and then overlappingly display the screen of the second item on the execution screen of the first item, in response to an input received from the input unit 120.

The item management unit 182 may store an item (e.g., calculator, housekeeping book, etc.), which has been executed a predetermined number of times or more when the first item is executed, in the memory 170 as a second item associated with the first item as shown in Table 2. The item management unit 182 may store an item, which has been added as a second item by a selection signal when the first item is executed, in the memory 170 as a second item associated with the first item as shown in Table 2.

The controller 180 may download an item from an external device. The category identification unit 181 may identify the category of the downloaded item and store the item in the memory 170 according to the identified category as shown in Table 1.

In one embodiment of the present disclosure, the electronic device 100 may include a memory 170 configured to store a first item and at least one second item and a controller 180 configured to identify at least one second item associated with the first item and display the at least one second item on an execution screen of the first item.

The controller 180 may identify a category of the first item and may identify a second item configured corresponding to the category. The second item may include at least one among an item having been executed a predetermined number of times or more when the first item is executed and an item selected as an associated item when the first item is executed.

The controller 180 may display a representative icon and, when the representative icon is selected, display second items arranged with reference to the representative icon in one shape among a radial shape, a linear shape, and a circular shape.

When a second item is selected, the controller 180 may overlappingly display an execution screen of the second item on the execution screen of the first item, and may change the position of the execution screen of the second item. The controller 180 may change the position at which the second icon is displayed, and may store the changed display position of the second icon as the display position of the second icon.

When a second item is selected, the controller 180 may contract the execution screen of the first item and change the display position of the contracted execution screen of the first item.

When receiving a signal for downloading a first item, the controller 180 may identify a category of the first item, generate an item group corresponding to the identified category, and store the first item in the generated item group.

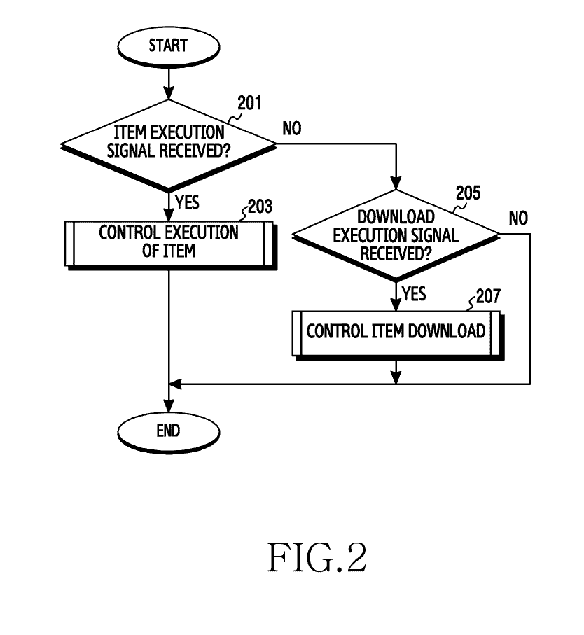

FIG. 2 is a flowchart for describing a display method according to an embodiment of the present disclosure.

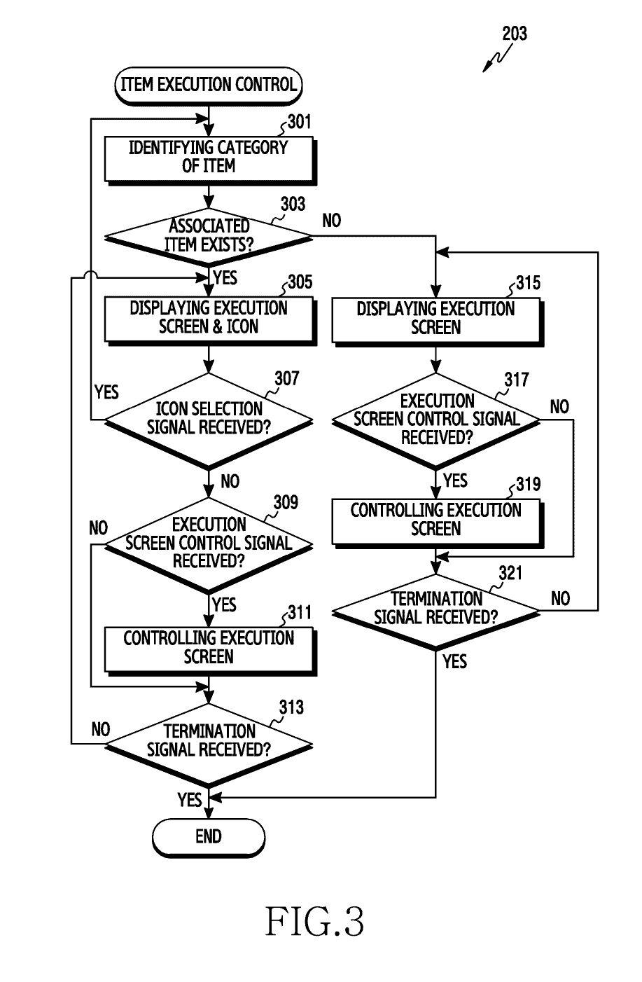

Referring to FIG. 2, when receiving an item execution signal for executing an item (hereinafter, referred to as a first item) from the input unit 120 in operation 201, the controller 180 may perform operation 203. In operation 203, the controller 180 may control execution of the first item. Operation 203 will be described below in more detail with reference to FIG. 3.

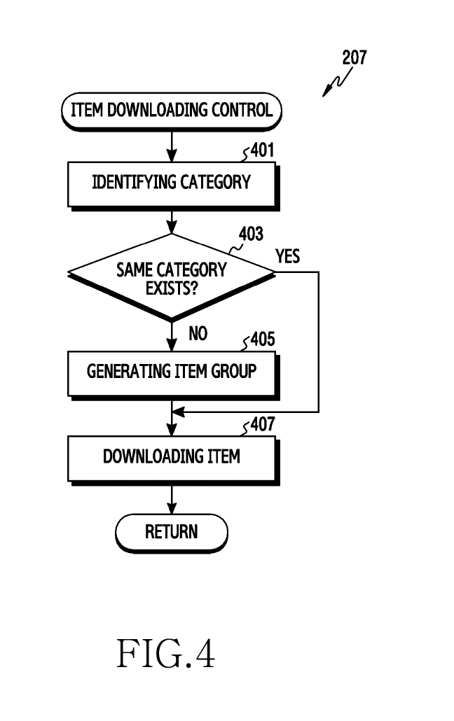

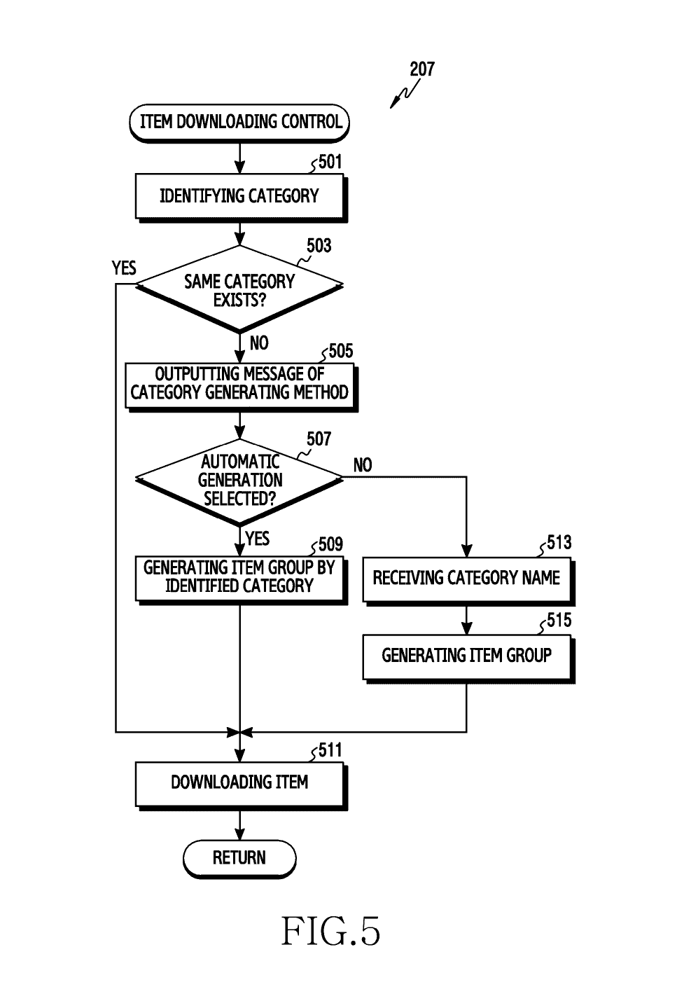

When the controller 180 does not receive an item execution signal, the controller 180 may perform operation 205. In operation 205, when receiving a download execution signal for downloading an item (hereinafter, referred to as first item) from the input unit 120 in operation 205, the controller 180 may perform operation 207. In operation 207, the controller 180 may control download execution of the first item. Operation 207 will be described below in more detail with reference to FIGS. 4 and 5.

FIG. 3 is a flowchart for describing a method of controlling execution of an item according to an embodiment of the present disclosure.

Referring to FIG. 3, in operation 301, the controller 180 may identify a category of the first item. In operation 303, the controller 180 may determine whether an item (hereinafter, referred to as second item) associated with the first item exists.

As a result of the determination in operation 303, when the second item exists, the controller 180 may perform operation 305. In operation 305, the controller 180 may display an icon of the second item at a predetermined position in an execution screen of the first item on the display unit 150. In operation 307, when an icon selection signal for the second item is received through the input unit 120, the controller 180 may return to operation 301.

When an icon selection signal for the second item is not received through the input unit 120 in operation 307, the controller 180 may perform operation 309. When a control signal for controlling the execution screen is received through the input unit 120 in operation 309, the controller 180 may perform operation 311. In operation 311, the controller 180 may control the execution screen of the first item displayed on the display unit 150, based on the received control signal.

When a control signal for controlling the execution screen is not received through the input unit 120 in operation 309, the controller 180 may perform operation 313. When a termination signal for the first item being executed is not received through the input unit 120 in operation 313, the controller 180 may return to operation 305 and then perform operations 305 to 313 again. When a termination signal for the first item being executed is received through the input unit 120 in operation 313, the controller 180 may terminate the process.

As a result of the determination in operation 303, when the second item does not exist, the controller 180 may perform operation 315. In operation 315, the controller 180 may display an execution screen of the first item on the display unit 150. When a control signal for controlling the execution screen is received through the input unit 120 in operation 317, the controller 180 may perform operation 319. In operation 319, the controller 180 may control the execution screen of the first item displayed on the display unit 150, based on the received control signal.

When a control signal for controlling the execution screen is not received through the input unit 120 in operation 317, the controller 180 may perform operation 321. When a termination signal for the first item being executed is not received through the input unit 120 in operation 321, the controller 180 may return to operation 315 and then perform operations 315 to 321 again. When a termination signal for the first item being executed is received through the input unit 120 in operation 321, the controller 180 may terminate the process.

FIG. 4 is a flowchart for describing a method of controlling downloading of an item according to an embodiment of the present disclosure.

Referring to FIG. 4, in operation 401, the controller 180 may identify a category configured for the first item corresponding to the download execution signal received in operation 205 of FIG. 2. The category is basically configured by an application developer when uploading the application to an application market, etc., and may include various categories including travel, finance, news, and game.

In operation 403, the controller 180 may determine whether an item group belonging to the same category as the category of the first item exists. As a result of the determination in operation 403, when an item group belonging to the same category as the category of the first item exists, the controller 180 may perform operation 407. In operation 407, the controller 180 may download the first item to the identified item group.

As a result of the determination in operation 403, when an item group belonging to the same category as the category of the first item does not exist, the controller 180 may perform operation 405. In operation 405, the controller 180 may generate an item group by the category of the first item. In operation 407, the controller 180 may download the first item to the generated item group.

FIG. 5 is a flowchart for describing a method of controlling downloading of an item according to another embodiment of the present disclosure.

Referring to FIG. 5, in operation 501, the controller 180 may identify a category configured for the first item corresponding to the download execution signal received in operation 205 of FIG. 2.

In operation 503, the controller 180 may determine whether an item group belonging to the same category as the category of the first item exists. As a result of the determination in operation 503, when an item group belonging to the same category as the category of the first item exists, the controller 180 may perform operation 511. In operation 511, the controller 180 may store the first item in the identified item group.

As a result of the determination in operation 503, when an item group belonging to the same category as the category of the first item does not exist, the controller 180 may perform operation 505. In operation 505, the controller 180 may display, on the display unit 150, a message for selecting a method of generating a category. When an input signal for automatically generating a category is received in operation 507, the controller 180 may perform operation 509. In operation 509, the controller 180 may generate an item group by the category of the first item. In operation 511, the controller 180 may download the first item to the generated item group.

When an input signal for automatically generating a category is not received in operation 507, the controller 180 may perform operation 513. In operation 513, the controller 180 may receive, from the user, a name of category for the item group to be generated. In operation 515, the controller 180 may generate an item group by the received category name By performing operation 511, the controller 180 may download the first item to the generated item group.

A display method according to an embodiment may include executing a first item, identifying at least one second item associated with the first item, and displaying the at least one second item on an execution screen of the first item.

The identifying the at least one second item may include identifying a category of the first item, and identifying a second item configured to belong to the category. The second item may include at least one among an item having been executed a predetermined number of times or more when the first item is executed and an item selected as an associated item when the first item is executed.

The displaying the at least one second item may include displaying a representative icon, and, when the representative icon is selected, displaying icons of second items arranged with reference to the representative icon in one shape among a radial shape, a linear shape, and a circular shape.

The display method may further include, when a second item is selected, overlappingly displaying an execution screen of the second item on the execution screen of the first item.

The display method may further include changing the position of the execution screen of the second item.

The displaying the at least one second item may include changing a position at which the second icon is displayed, and storing the changed display position of the second icon as the display position of the second icon.

The display method may further include, when a second item is selected, contracting and displaying the execution screen of the first item. The display method may further include changing the display position of the contracted execution screen of the first item.

The display method may further include identifying the category of the first item when a signal for downloading the first item is received, and storing the first item in an item group corresponding to the identified category.

The display method may further include generating an item group belonging to a category, and storing the first item in the generated item group. The display method may further include receiving a name for an item group, generating the item group by the received name, and storing the first item in the generated item group.

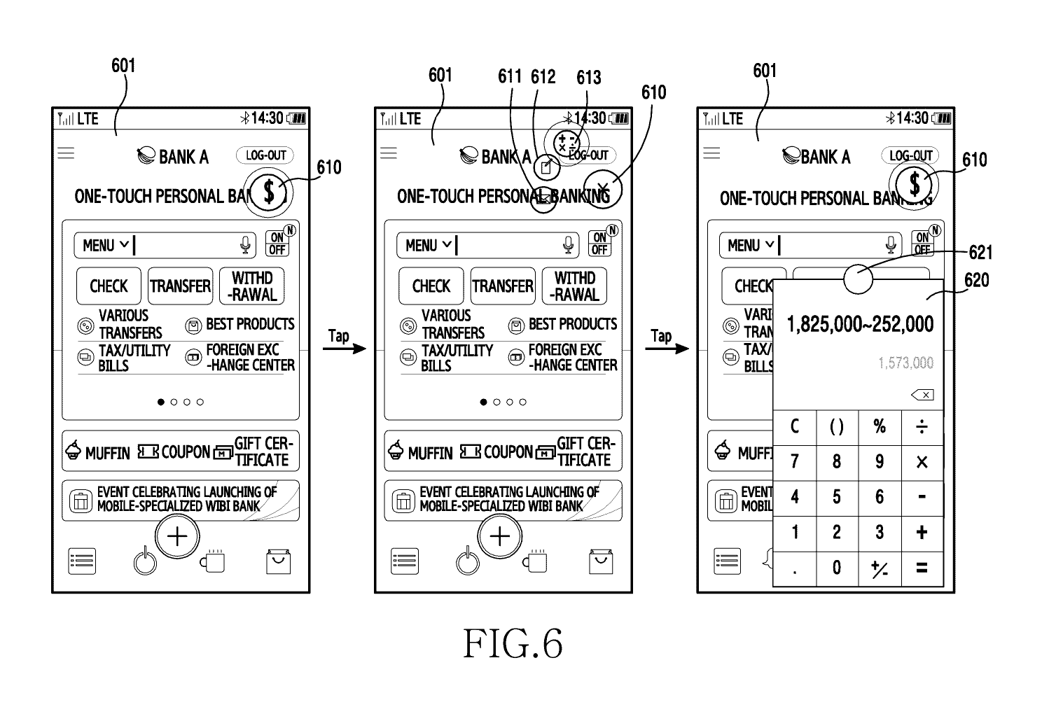

FIG. 6 illustrates an example of a screen for describing a method of displaying a second item on an execution screen of a first item associated with finance according to an embodiment of the present disclosure.

Referring to FIG. 6, when an execution signal for “bank A,” which is the first item, is received through the input unit 120, the controller 180 may display an execution screen 601 of “bank A” on the display unit 150. Then, the controller 180 may display a representative icon 610 for second items, using a currency symbol ($), at a predetermined position on the execution screen 601.

When the representative icon 610 is selected through the input unit 120, the controller 180 may display icons 611, 612, and 613 of second items associated with “bank A.” The icons 611, 612, and 613 of the second items may be icons for executing items stored in association with “bank A” as shown in Tables 1 and 2. The controller 180 may enlargedly display the icons 611, 612, and 613 of the second items while changing the displayed representative icon 610 into a shape of “X.”

When the representative icon 610 displayed in the changed shape of “X” is selected through the input unit 120, the controller 180 may contract the enlargedly displayed icons 611, 612, and 613 and display only the representative icon 610 having the shape of the currency symbol ($).

When a calculator icon 613 is selected from the icons 611, 612, and 613, the controller 180 may overlappingly display an execution screen 620 of the calculator, which is a second item, on the execution screen 601 of “bank A.” While executing the calculator, the controller 180 may change the representative icon 610 into the shape of the currency symbol ($) again.

When an indicator 621 of the calculator is selected through the input unit 120, the controller 180 may prevent the execution screen 620 of the calculator excluding the indicator 621 from being displayed on the execution screen 601 of “bank A.” Here, the controller 180 may perform a function according to a command input to the execution screen 601 of “bank A” through the input unit 120. When the indicator 621 is selected again through the input unit 120, the controller 180 may display again the execution screen 620 of the calculator on the execution screen 601 of “bank A.”

According to a movement of the indicator 621, the controller 180 may display the execution screen 620 of the calculator moving on the execution screen 601 of “bank A.” When a dragging signal is generated on an edge of the calculator execution screen 620 by the input unit 120, the controller 180 may contract or expand the execution screen 620 of the calculator according to the generated signal.

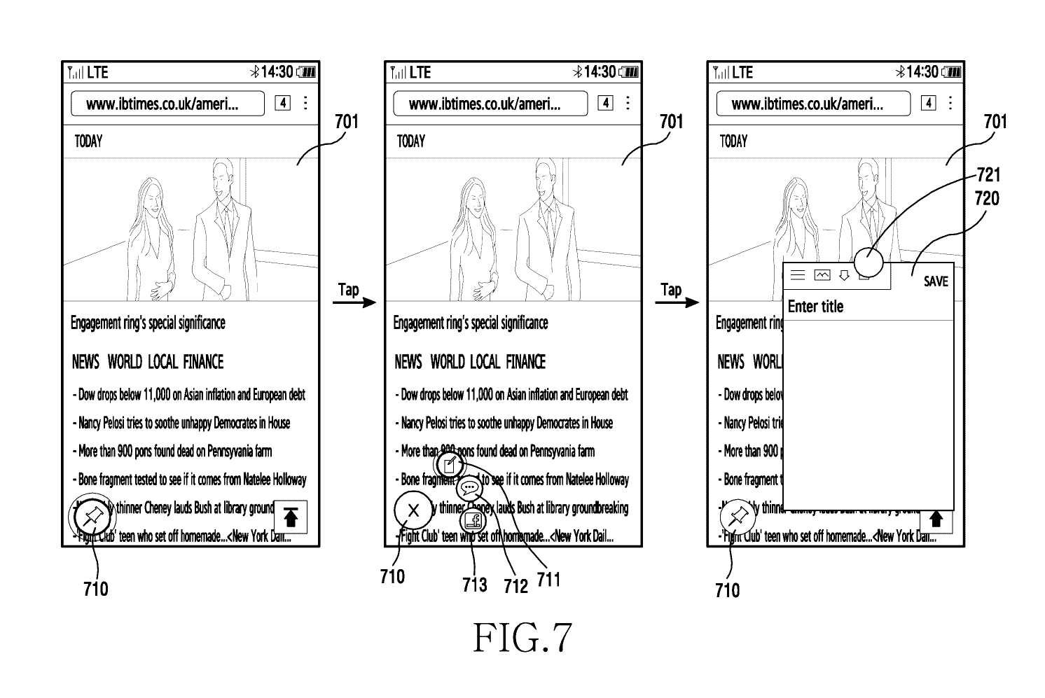

FIG. 7 illustrates an example of a screen for describing a method of displaying a second item on an execution screen of a first item associated with a web browser according to an embodiment of the present disclosure.

Referring to FIG. 7, when an execution signal for “newspaper C,” which is the first item, is received through the input unit 120, the controller 180 may display an execution screen 701 of “newspaper C” on the display unit 150. Then, the controller 180 may display a representative icon 710 for second items, in a shape of a pin, at a predetermined position on the execution screen 701.

When the representative icon 710 is selected through the input unit 120, the controller 180 may display icons 711, 712, and 713 of second items associated with “newspaper C.” The icons 711, 712, and 713 of the second items may be icons for executing items stored in association with “newspaper C” as shown in Tables 1 and 2. The controller 180 may enlargedly display the icons 711, 712, and 713 of the second items while changing the shape of the displayed representative icon 710 into a shape of “X.”

When the representative icon 710 displayed in the changed shape of “X” is selected through the input unit 120, the controller 180 may contract the enlargedly displayed icons 711, 712, and 713 and display only the representative icon 710 having a shape of a pin.

When a memo icon 711 is selected from the icons 711, 712, and 713, the controller 180 may overlappingly display an execution screen 720 of the menu, which is a second item, on the execution screen 701 of “newspaper C.” While executing the memo, the controller 180 may change the representative icon 710 into the shape of the pin again.

When an indicator 721 of the memo is selected through the input unit 120, the controller 180 may prevent the execution screen 720 of the memo excluding the indicator 721 from being displayed on the execution screen 701 of “newspaper C.” Here, the controller 180 may perform a function (e.g., text copying, etc.) according to a command input to the execution screen 701 of “newspaper C” through the input unit 120. When the indicator 721 is selected again through the input unit 120, the controller 180 may display again the execution screen 720 of the memo on the execution screen 701 of “newspaper C.” The controller 180 may paste a text, which has been copied in the execution screen 701 of “newspaper C” by the input unit 120, into the execution screen 720 of the memo.

According to a movement of the indicator 721, the controller 180 may display the execution screen 720 of the memo moving on the execution screen 701 of “newspaper C.” When a dragging signal is generated on an edge of the memo execution screen 720 by the input unit 120, the controller 180 may contract or expand the execution screen 720 of the memo according to the generated signal.

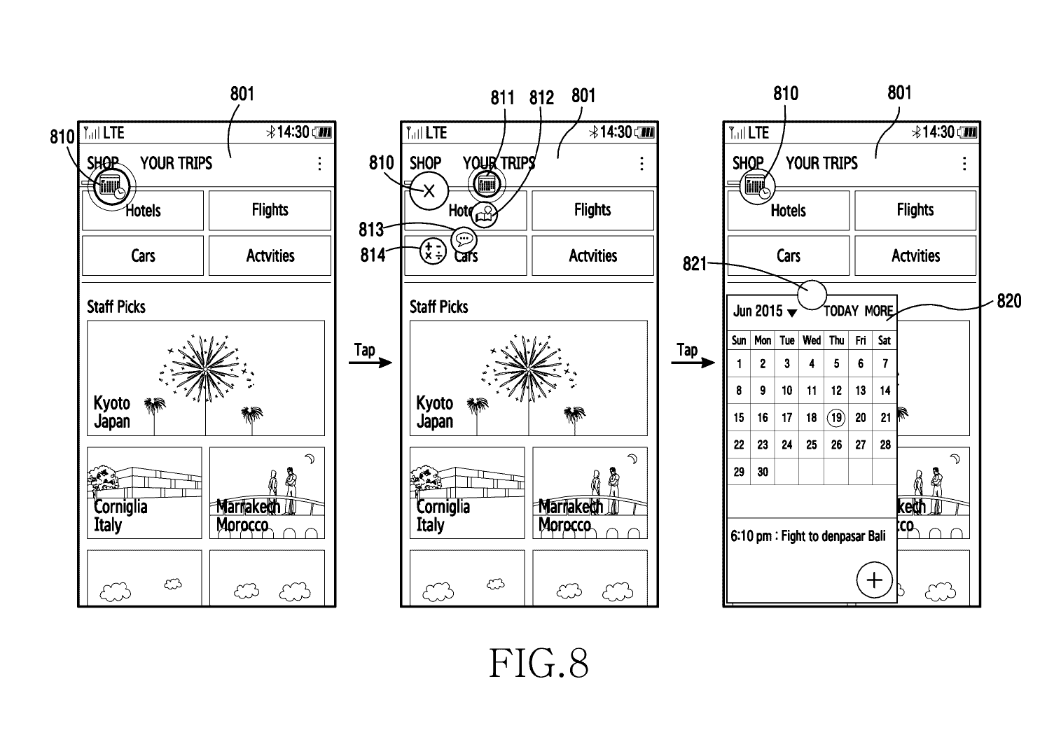

FIG. 8 illustrates an example of a screen for describing a method of displaying a second item on an execution screen of a first item associated with travel information according to an embodiment of the present disclosure.

Referring to FIG. 8, when an execution signal for “travel agency H,” which is the first item, is received through the input unit 120, the controller 180 may display an execution screen 801 of “travel agency H” on the display unit 150. Then, the controller 180 may display a representative icon 810 for second items, in a shape of a schedule, at a predetermined position on the execution screen 801.

When the representative icon 810 is selected through the input unit 120, the controller 180 may display icons 811, 812, 813, and 814 of second items associated with “travel agency H.” The icons 811, 812, 813, and 814 of the second items may be icons for executing items stored in association with “travel agency H” as shown in Tables 1 and 2. The controller 180 may enlargedly display the icons 811, 812, 813, and 814 of the second items while changing the displayed representative icon 810 into a shape of “X.”

When the representative icon 810 displayed in the changed shape of “X” is selected through the input unit 120, the controller 180 may contract the enlargedly displayed icons 811, 812, 813, and 814 and display only the representative icon 810 having a shape of a schedule.

When a calendar icon 811 is selected from the second icons 811, 812, 813, and 814, the controller 180 may overlappingly display an execution screen 820 of the calendar, which is a second item, on the execution screen 801 of “travel agency H.” While executing the calendar, the controller 180 may change the representative icon 810 into the shape of the calendar again.

When an indicator 821 of the calendar is selected through the input unit 120, the controller 180 may prevent the execution screen 820 of the calendar excluding the indicator 821 from being displayed on the execution screen 801 of “travel agency H.” Here, the controller 180 may perform a function (e.g., storing travel date and boarding time reserved in the travel agency) according to a command input to the execution screen 801 of “travel agency H” through the input unit 120. When the indicator 821 is selected again through the input unit 120, the controller 180 may display again the execution screen 820 of the calendar on the execution screen 801 of “travel agency H.”

According to a movement of the indicator 821, the controller 180 may display the execution screen 820 of the calendar moving on the execution screen 801 of “travel agency H.” When a dragging signal is generated on an edge of the calendar execution screen 820 by the input unit 120, the controller 180 may contract or expand the execution screen 820 of the calendar according to the generated signal.

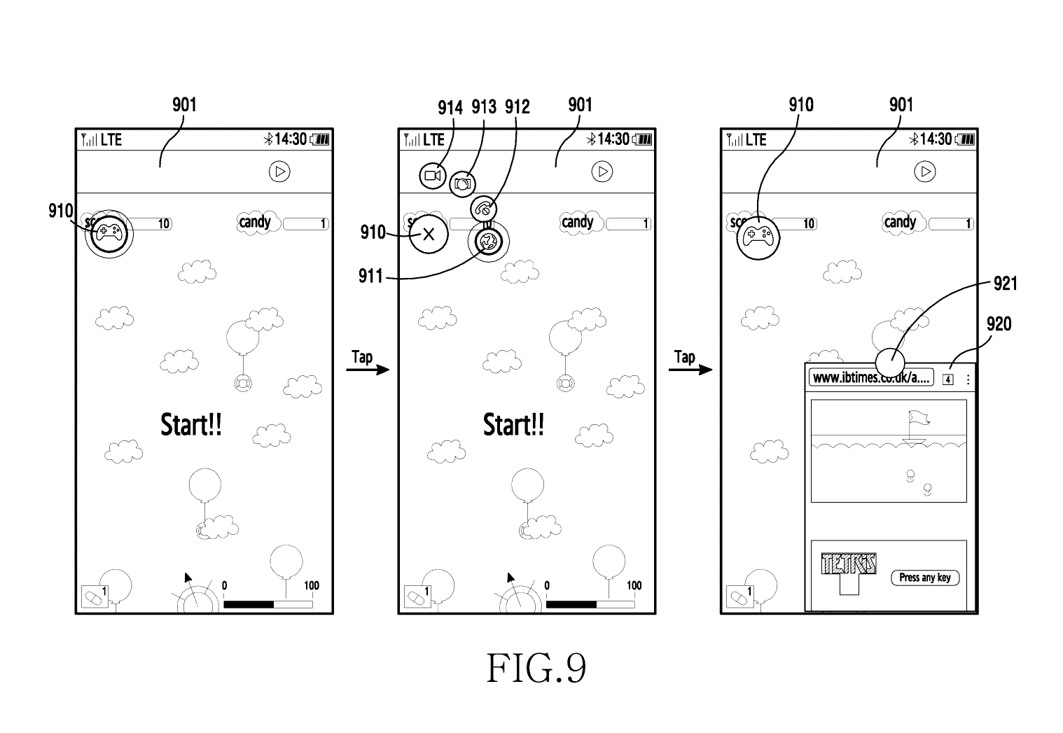

FIG. 9 illustrates an example of a screen for describing a method of displaying a second item on an execution screen of a first item associated with a game according to an embodiment of the present disclosure.

Referring to FIG. 9, when an execution signal for “balloon bursting,” which is the first item, is received through the input unit 120, the controller 180 may display an execution screen 901 of “balloon bursting” on the display unit 150. Then, the controller 180 may display a representative icon 910 for second items, in a shape of an operating device, at a predetermined position on the execution screen 901.

When the representative icon 910 is selected through the input unit 120, the controller 180 may display icons 911, 912, 913, and 914 of second items associated with “balloon bursting.” The icons 911, 912, 913, and 914 of the second items may be icons for executing items stored in association with “balloon bursting” as shown in Tables 1 and 2. The controller 180 may enlargedly display the icons 911, 912, 913, and 914 of the second items while changing the shape of the displayed representative icon 910 into a shape of “X.”

When the representative icon 910 displayed in the changed shape of “X” is selected through the input unit 120, the controller 180 may contract the enlargedly displayed icons 911, 912, 913, and 914 and display only the representative icon 910 having a shape of an operating device.

When a web browser icon 911 is selected from the icons 911, 912, 913, and 914, the controller 180 may overlappingly display an execution screen 920 of the web browser, which is a second item, on the execution screen 901 of “balloon bursting.” The execution screen 920 of the web browser may be a game provider website providing the game of “balloon bursting” as shown in Table 2. While executing the game provider website, the controller 180 may change the representative icon 910 into the shape of the operating device again.

When an indicator 921 of the game provider website is selected through the input unit 120, the controller 180 may prevent the execution screen 920 of the game provider website excluding the indicator 921 from being displayed on the execution screen 901 of “balloon bursting.” Here, the controller 180 may perform a function according to a command input to the execution screen 901 of “balloon bursting” through the input unit 120. When the indicator 921 is selected again through the input unit 120, the controller 180 may display again the execution screen 920 of the game provider website on the execution screen 901 of “balloon bursting.”

According to a movement of the indicator 921, the controller 180 may display the execution screen 920 of the game provider website moving on the execution screen 901 of “balloon bursting.” When a dragging signal is generated on an edge of the execution screen 920 of the game provider website by the input unit 120, the controller 180 may contract or expand the execution screen 920 of the game provider website according to the generated signal.

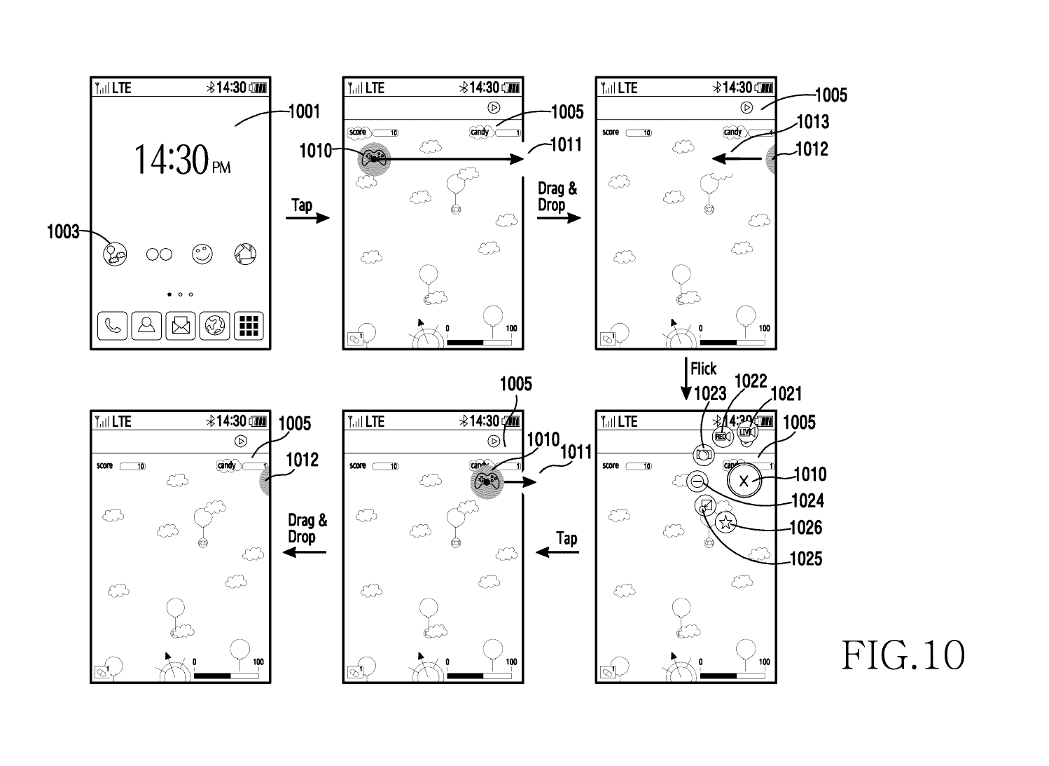

FIG. 10 illustrates an example of a screen for describing a method of changing a position of a second item on an execution screen of a first item according to an embodiment of the present disclosure.

Referring to FIG. 10, the controller 180 may display a standby screen 1001 on the display unit 150. The controller 180 may receive, from the input unit 120, a selection signal for an icon 1003 in the standby screen 1001. The controller 180 may execute a first item for the selected icon 1003 and display an execution screen 1005. The controller 180 may display a representative icon 1010 for second items at a predetermined position on the execution screen 1005.

When a drag-and-drop signal for the representative icon 1010 displayed on the execution screen 1005 is received by the input unit 120, the controller 180 may move the representative icon 1010 to the position 1011 at which the drop signal is detected. The controller 180 may display a part of the representative icon 1010 at the position 1011 at which the drop signal is detected.

When the moved representative icon 1012 is flicked in the leftward direction 1013, the controller 180 may display icons 1021, 1022, 1023, 1024, 1025, and 1026 of second items associated with the first item on the execution screen 1005 of the first item. The controller 180 may enlargedly display the icons 1021, 1022, 1023, 1024, 1025, and 1026 of the associated second items while changing the displayed representative icon 1010 into a shape of “X.”

When the representative icon 1010, the displayed shape of which has been changed into the shape of “X,” is selected, the controller 180 may contract the enlargedly displayed icons 1021, 1022, 1023, 1024, 1025, and 1026 and display again a part 1012 of the representative icon 1010 at the position 1011 at which the drop signal is detected. The icons 1021, 1022, 1023, 1024, 1025, and 1026 may be an icon 1021 for executing an item for broadcasting a first item (e.g., game), an icon 1022 for executing an item for recording the first item being executed, an icon 1023 for executing an item for capturing a current screen of the first item being executed, an icon 1024 for executing an item for hiding a phone call or alarm generated during execution of the first item, an icon 1025 for executing an item for minimizing the execution screen of the first item during the execution of the first item, and an icon 1026 for executing an item for opening a bookmark item or web browser, respectively.

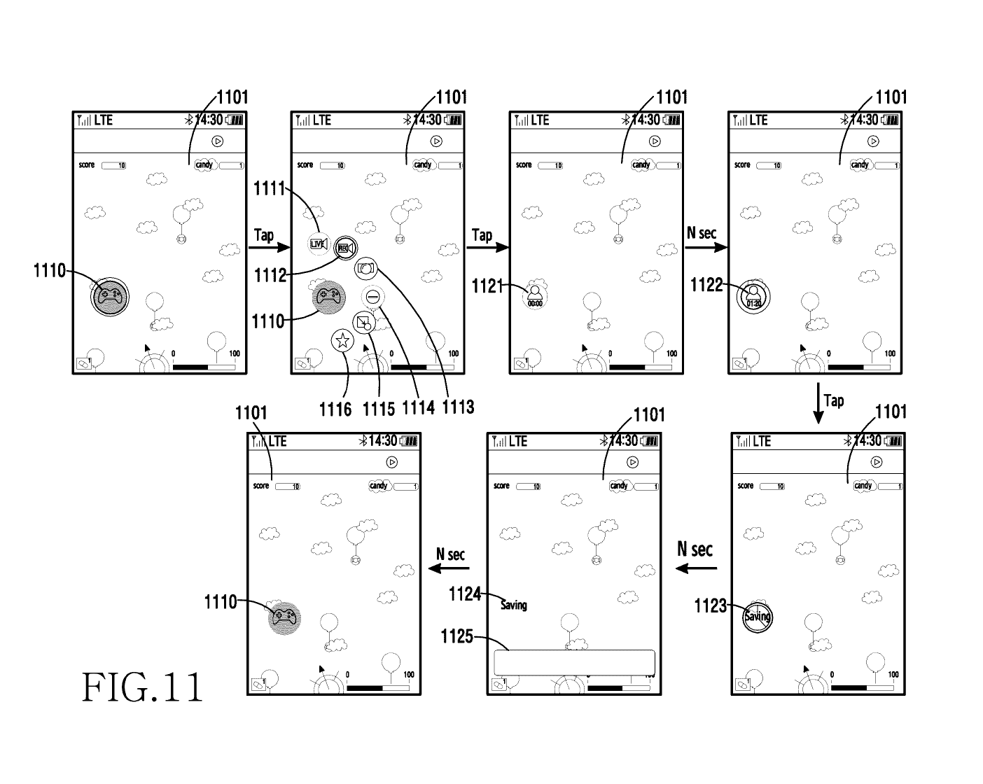

FIG. 11 illustrates an example of a screen for describing a method of recording an execution screen of a first item using a second item according to an embodiment of the present disclosure.

Referring to FIG. 11, the controller 180 displays an execution screen 1101 of the first item on the display unit 150 and may display a representative icon 1110 of second items associated with the first item at a predetermined position of the execution screen 1101.

When a selection signal for the representative icon 1110 is received through the input unit 120, the controller 180 may enlargedly display icons 1111, 1112, 1113, 1114, 1115, and 1116 of the second items. When a record icon 1112 is selected from the icons 1111, 1112, 1113, 1114, 1115, and 1116 of the second items, the controller 180 may execute the recording, which is a second item. While the recording is being executed, the controller 180 may change the record icon 1112 to an in-recording icon 1121 and display a recording time (00:00).

When an input is generated for the in-recording icon 1121, the controller 180 may change the in-recording icon 1121 to an icon 1122 indicating the completion of the recording and display the recording time (01:20) in the icon 1122.

The controller 180 may store data, the recording of which has been completed. At the time of storing the data, the controller 180 may display an icon 1123 indicating that the data is being stored. The controller 180 may display a color, which indicates the quantity of stored data increasing according to passage of the storing time, in the icon 1123. When the storage of the data is completed, the controller 180 may indicate an icon 1124 indicating the completion of the storing and may display a message 1125 at the bottom of the execution screen 1101.

When a predetermined period of time (N seconds) passes after displaying the storage completion icon 1124 and the message 1125, the controller 180 may display again the representative icon 1110 for the execution screen 1101 on the display unit 150. The controller 180 may not display the storage completion icon 1124 and the message 1125 on the display unit 150.

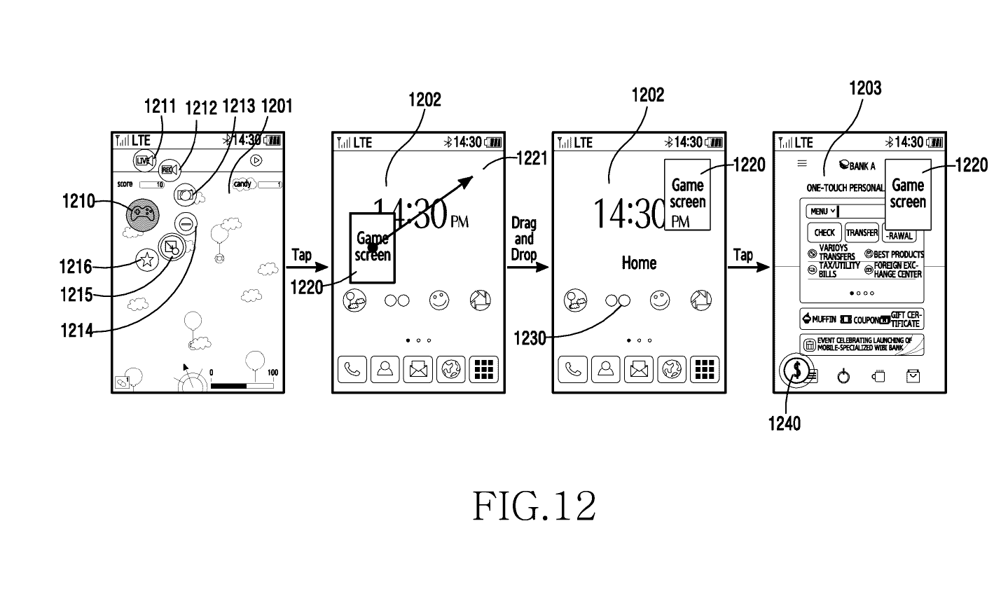

FIG. 12 illustrates an example of a screen for describing a method of contracting an execution screen of a first item using a second item according to an embodiment of the present disclosure.

Referring to FIG. 12, the controller 180 displays an execution screen 1201 of the first item on the display unit 150 and may display a representative icon 1210 of second items associated with the first item at a predetermined position of the execution screen 1201.

When a selection signal for the representative icon 1210 is received through the input unit 120, the controller 180 may enlargedly display icons 1211, 1212, 1213, 1214, 1215, and 1216 of the second items. The controller 180 may detect a selection of a minimization icon 1211 for minimizing the execution screen 1201 among the icons 1211, 1212, 1213, 1214, 1215, and 1216 of the second items.

When the minimization icon 1211 is selected, the controller 180 may display a standby screen 1202 on the display unit 150 and may overlappingly display the minimized screen 1220, which is obtained by minimizing the execution screen 1201 of the first item, on the standby screen 1202. When a drag-and-drop signal for moving the minimized screen 1220 to a particular position 1221 is received, the controller 180 may move the minimized screen 1220 to the position 1221 at which the drop signal is detected.

When an icon 1230 of another first item different from the previous first item among a plurality of icons displayed on the standby screen 1202, the controller 180 may display an execution screen 1203 of the other first item on the display unit 150. The controller 180 may overlappingly display the minimized screen 1220 on an execution screen 1203 of the other first item without terminating the previous first item. The controller 180 may display a representative icon 1240 of items associated with the icon 1230 of the other first item at a predetermined position on the execution screen 1203 of the other first item. Here, when the other first item is “bank A,” the representative icon 1240 of the second items should be displayed at the right upper end of the display unit 150 as shown in FIG. 6. However, since the execution screen 1220 of the previous first item is already displayed on the right upper end of the display unit 150, the controller 180 may display the representative icon 1240 on the left lower end of the display unit 150.

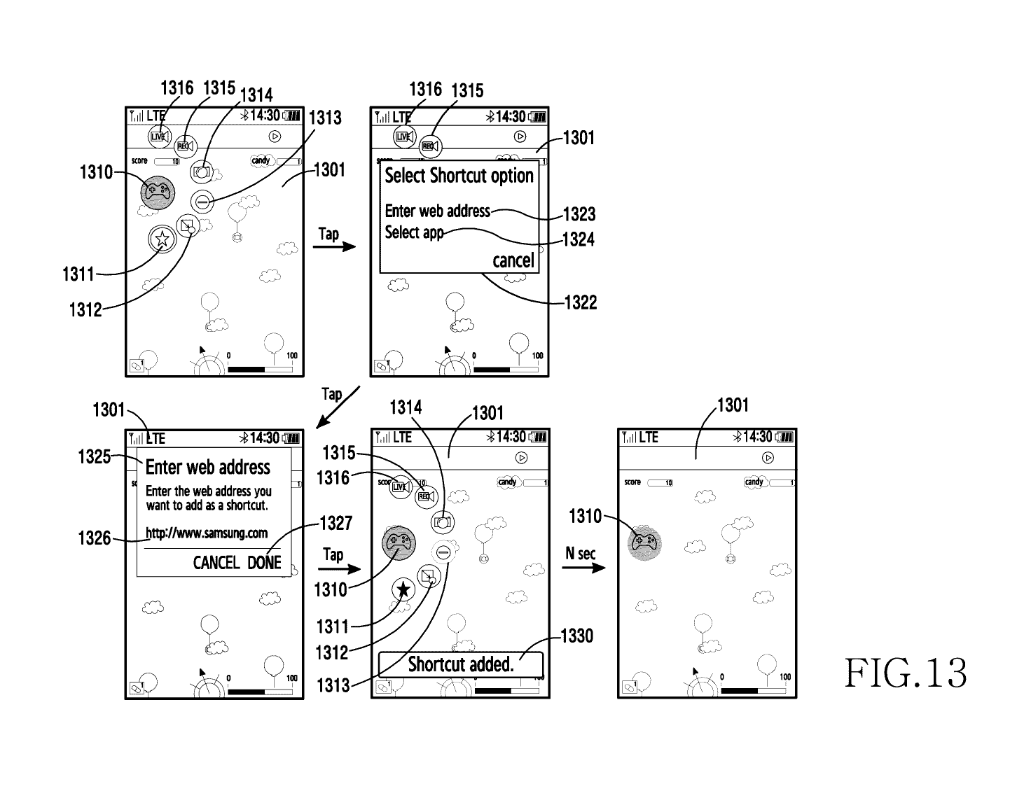

FIG. 13 illustrates an example of a screen for describing a method of adding a web browser as a second item on an execution screen of a first item according to an embodiment of the present disclosure.

Referring to FIG. 13, the controller 180 displays an execution screen 1301 of the first item on the display unit 150 and may display a representative icon 1310 of second items associated with the first item at a predetermined position of the execution screen 1301.

When a selection signal for the representative icon 1310 is received through the input unit 120, the controller 180 may enlargedly display icons 1311, 1312, 1313, 1314, 1315, and 1316 of the second items. When a bookmark adding icon 1311 is selected from the icons 1311, 1312, 1313, 1314, 1315, and 1316 of the second items, the controller 180 may execute the bookmark adding, which corresponds to the selected icon 1311.

The controller 180 may overlappingly display the execution screen 1322 of the bookmark adding on an execution screen 1301 of the first item. The execution screen 1322 of the bookmark adding may display an item 1323 for directly inputting a web address to add the web address in the bookmark, and an item 1324 for selecting an item (e.g., application) among items stored in the electronic device to add the selected item in the bookmark.

When the item 1323 for directly inputting a web address to add the web address in the bookmark is selected in the execution screen 1322 of the bookmark adding, the controller 180 may display an execution screen 1325 for inputting a web address on the display unit 150. The controller 180 may detect inputting of a web address in a blank 1326 and selection of a completion menu 1327 in the execution screen 1325 for inputting a web address.

The controller 180 may add the web address input to the blank 1326 to the bookmark, and may change the color of the bookmark adding icon 1311 when the adding has been completed. The controller 180 may store the web address having been added in the bookmark as a second item associated with the first item as shown in Table 2. When the bookmark adding of the web address is completed, the controller 180 may output a message 1330 notifying of the completion of the bookmark adding at the lower end of the execution screen 1301 of the first item. After the bookmark adding is completed, when a threshold time (N sec) has passed, the controller 180 may display again only the representative icon 1310 of the second items on the execution screen 1301 of the first item.

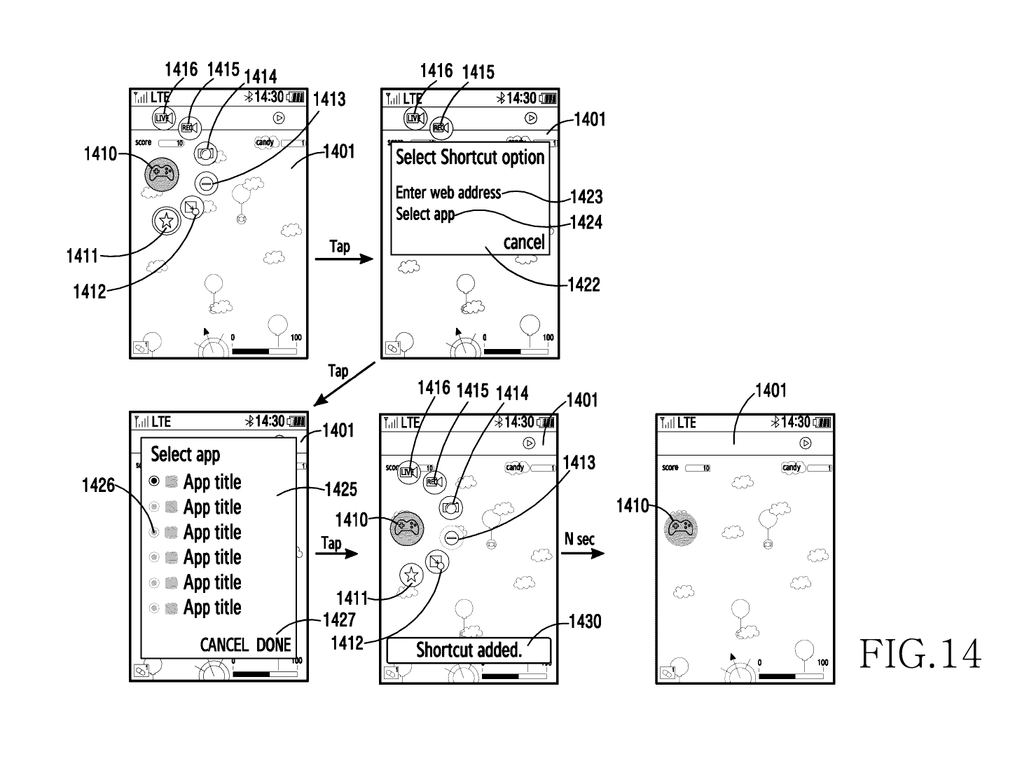

FIG. 14 illustrates an example of a screen for describing a method of adding another item as a second item on an execution screen of a first item according to an embodiment of the present disclosure.

Referring to FIG. 14, the controller 180 displays an execution screen 1401 of the first item on the display unit 150 and may display a representative icon 1410 of second items associated with the first item at a predetermined position of the execution screen 1401.

When a selection signal for the representative icon 1410 is received through the input unit 120, the controller 180 may enlargedly display icons 1411, 1412, 1413, 1414, 1415, and 1416 of the second items. When a bookmark adding icon 1411 is selected from the icons 1411, 1412, 1413, 1414, 1415, and 1416 of the second items, the controller 180 may execute the bookmark adding, which corresponds to the selected icon 1411.

The controller 180 may overlappingly display the execution screen 1422 of the bookmark adding on an execution screen 1401 of the first item. The execution screen 1422 of the bookmark adding may display an item 1423 for directly inputting a web address to add the web address in the bookmark, and an item 1424 for selecting an item (e.g., application) among items stored in the electronic device to add the selected item in the bookmark.

When the item 1424 for selecting an item to add the item in the bookmark is selected in the execution screen 1422 of the bookmark adding, the controller 180 may display a list 1425 of items stored in the electronic device. The controller 180 may detect selecting 1426 of a particular item in the list 1425 of the items and selecting of a completion menu 1427.

The controller 180 may add the selected particular item 1426 to the bookmark, and may change the color of the bookmark adding icon 1411 when the adding is completed. The controller 180 may store the item having been added in the bookmark as a second item associated with the first item as shown in Table 2. When the bookmark adding of the item is completed, the controller 180 may output a message 1430 notifying of the completion of the bookmark adding at the lower end of the execution screen 1401 of the first item. After the bookmark adding is completed, when a threshold time (N sec) has passed, the controller 180 may display again only the representative icon 1410 of the second items on the execution screen 1401 of the first item.

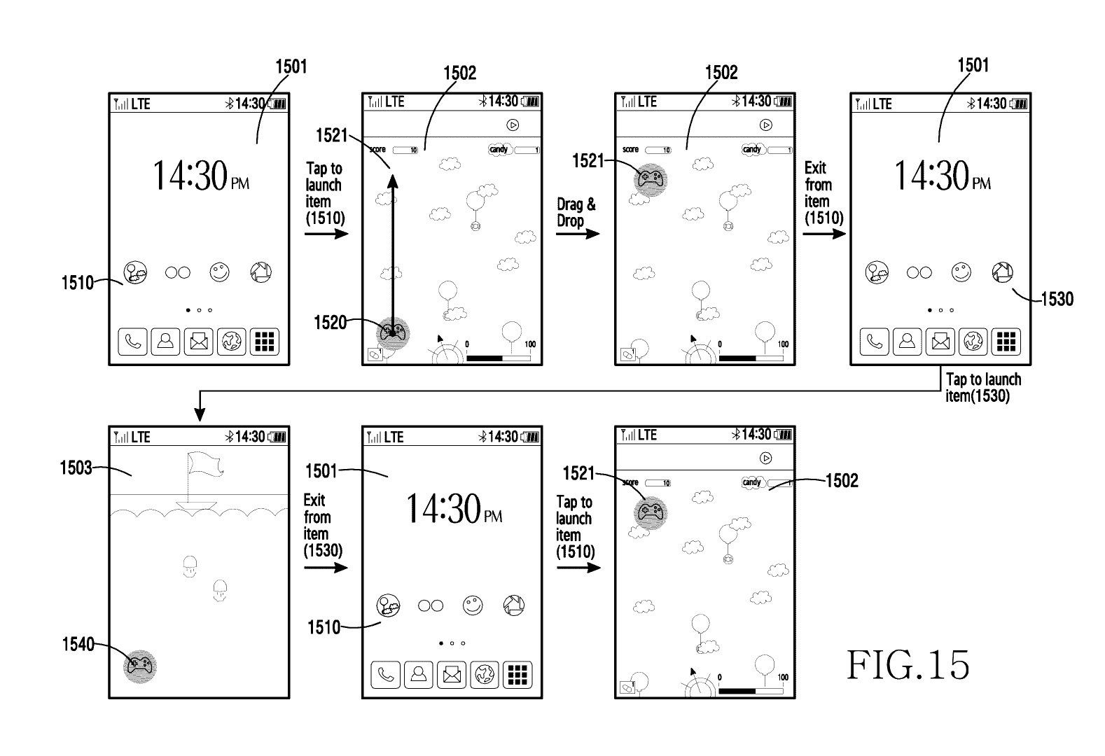

FIG. 15 illustrates an example of a screen for describing a method of configuring a position of a second item on an execution screen of a first item according to an embodiment of the present disclosure.

Referring to FIG. 15, the controller 180 may display a standby screen 1501 on the display unit 150. The controller 180 may receive, from the input unit 120, a selection signal for an icon 1510 in the standby screen 1501. The controller 180 may execute a first item for the selected icon 1510 and display an execution screen 1502. The controller 180 may display a representative icon 1520 for second items at a predetermined position on the execution screen 1502.

When a drag-and-drop signal for the representative icon 1520 displayed on the execution screen 1502 is received by the input unit 120, the controller 180 may move and display the representative icon 1520 to the position 1521 at which the drop signal is detected.

When a signal for displaying the standby screen 1501 is input in the state where the execution screen 1502 of the first item is being displayed, the controller 180 may execute the first item in the background of the electronic device and may display the standby screen 1501 in the foreground thereof.

The controller 180 may receive, from the input unit 120, a selection signal for another icon 1530 in the standby screen 1501. The controller 180 may execute another first item for the selected another icon 1530 and display an execution screen 1503. The controller 180 may display a representative icon 1540 for second items at a predetermined position on the execution screen 1503.

When a signal for displaying the standby screen 1501 is input in the state where the execution screen 1503 of the other first item is being displayed, the controller 180 may execute the other first item in the background of the electronic device and may display the standby screen 1501 in the foreground thereof.

When a selection signal for the icon 1510 is received again from the input unit 120 in the standby screen 1501, the controller 180 may display the execution screen 1502 of the first item corresponding to the icon 1510, on the display unit 150. The controller 180 may display the representative icon 1520 of a second item associated with the first item corresponding to the icon 1510 at the position 1521 changed through the drag-and-drop.

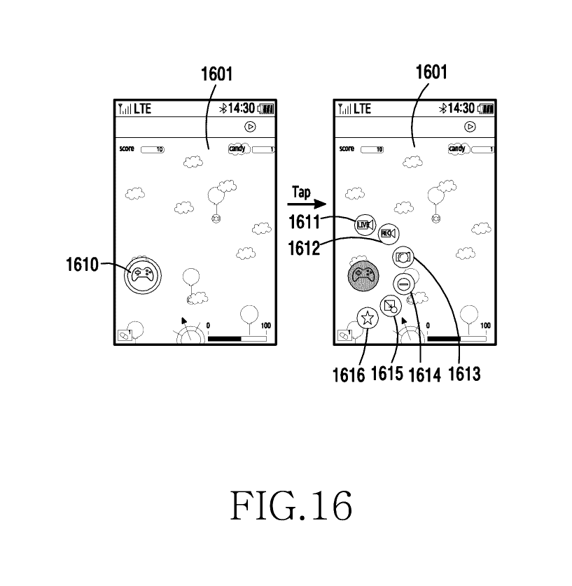

FIG. 16 illustrates an example of a screen for describing a method of displaying a second item according to an embodiment of the present disclosure.

Referring to FIG. 16, the controller 180 displays an execution screen 1601 of the first item on the display unit 150 and may display a representative icon 1610 of second items associated with the first item at a predetermined position of the execution screen 1601.

When a selection signal for the representative icon 1610 is received through the input unit 120, the controller 180 may display icons 1611, 1612, 1613, 1614, 1615, and 1616 of the second items in a semi-circular shape enlarged around the representative icon 1610.

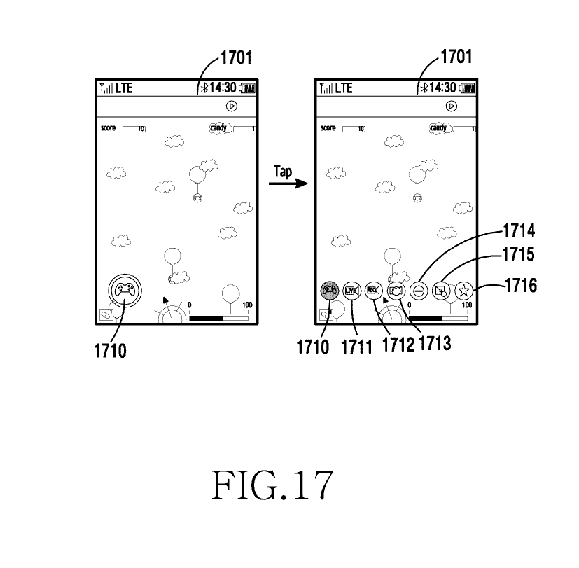

FIG. 17 illustrates an example of a screen for describing a method of displaying a second item according to another embodiment of the present disclosure.

Referring to FIG. 17, the controller 180 displays an execution screen 1701 of the first item on the display unit 150 and may display a representative icon 1710 of second items associated with the first item at a predetermined position of the execution screen 1701.

When a selection signal for the representative icon 1710 is received through the input unit 120, the controller 180 may display icons 1711, 1712, 1713, 1714, 1715, and 1716 of the second items in an enlarged linear form on the lower end of the execution screen 1701.

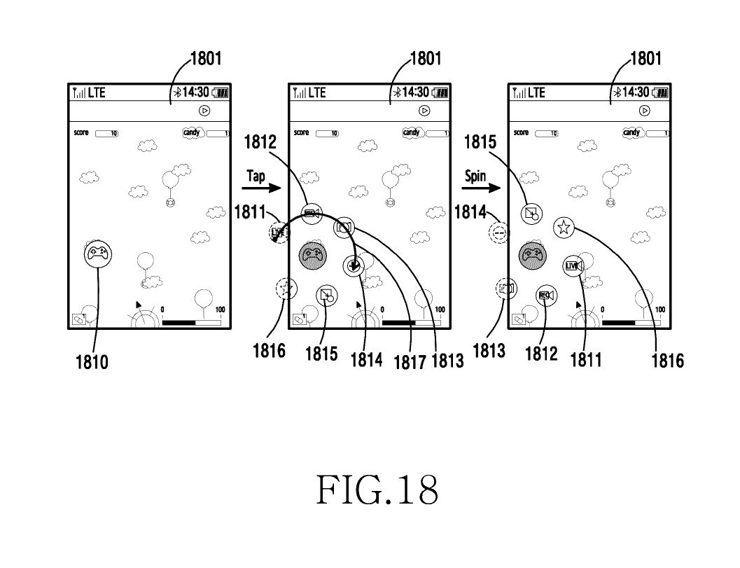

FIG. 18 illustrates an example of a screen for describing a method of displaying a second item according to still another embodiment of the present disclosure.

Referring to FIG. 18, the controller 180 displays an execution screen 1801 of the first item on the display unit 150 and may display a representative icon 1810 of second items associated with the first item at a predetermined position of the execution screen 1801.

When a selection signal for the representative icon 1810 is received through the input unit 120, the controller 180 may display icons 1811, 1812, 1813, 1814, 1815, and 1816 of the second items in a circular shape enlarged around the representative icon 1610. In this event, among the icons 1811, 1812, 1813, 1814, 1815, and 1816, only the icons 1812, 1813, 1814, and 1815 may be displayed while only a part of the icons 1811 and 1816 is displayed.

When a drag signal in the direction of arrow 1817 is input to display the icons 1811 and 1816, the controller 180 may display the icons 1811, 1812, 1813, 1814, 1815, and 1816 on the display unit 150 after rotating the icons by an amount corresponding to the input drag signal.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A display method comprising:
executing a first item;
identifying at least one second item associated with the first item; and
displaying the at least one second item on an execution screen of the first item.

2. The display method of claim 1, wherein the identifying of the at least one second item comprises:
identifying a category of the first item; and
identifying the at least one second item configured to belong to the category.

3. The display method of claim 1, wherein the at least one second item comprises at least one item among an item having been executed a predetermined number of times or more when the first item is executed and an item selected as an associated item when the first item is executed.

4. The display method of claim 1, wherein the displaying of the at least one second item comprises:
displaying a representative icon; and
when the representative icon is selected, displaying icons of the at least one second item arranged, with reference to the representative icon, in one shape among a radial shape, a linear shape, and a circular shape.

5. The display method of claim 4, further comprising:
when a second item is selected, overlappingly displaying an execution screen of the second item on the execution screen of the first item.

6. The display method of claim 5, further comprising:
changing a position of the execution screen of the second item.

7. The display method of claim 4, wherein the displaying of the at least one second item comprises:
changing a position at which the at least one second item is displayed; and
storing the changed position at which the at least one second item is displayed, as a display position of the at least one second item.

8. The display method of claim 4, further comprising:
when a second item is selected, contracting and displaying the execution screen of the first item.

9. The display method of claim 8, further comprising:
changing a display position of the contracted execution screen of the first item.

10. The display method of claim 1, further comprising:
when a signal for downloading the first item is received, identifying a category of the first item; and
storing the first item in an item group corresponding to the category.

11. The display method of claim 10, further comprising:
generating the item group corresponding to the category; and
storing the first item in the generated item group.

12. The display method of claim 10, further comprising:
receiving a name of an item group;
generating an item group by the name; and
storing the first item in the generated item group.

13. An electronic device comprising:
a memory configured to store a first item and at least one second item associated with the first item; and
a controller configured to:
identify the at least one second item associated with the first item, and
display the at least one second item on an execution screen of the first item.

14. The electronic device of claim 13, wherein the controller is further configured to identify a category of the first item and identifies the at least one second item configured to belong to the category.

15. The electronic device of claim 13, wherein the at least one second item comprises at least one item among an item having been executed a predetermined number of times or more when the first item is executed and an item selected as an associated item when the first item is executed.

16. The electronic device of claim 13, wherein the controller is further configured to:
display a representative icon and,
when the representative icon is selected, display icons of the at least one second item arranged, with reference to the representative icon, in one shape among a radial shape, a linear shape, and a circular shape.

17. The electronic device of claim 16, wherein, when a second item is selected, the controller is further configured to:
overlappingly display an execution screen of the second item on the execution screen of the first item, and
change a position of the execution screen of the second item.

18. The electronic device of claim 16, wherein the controller is further configured to:
change a position at which the second icon is displayed, and
store the changed position at which the second icon is displayed, as a display position of the second icon.

19. The electronic device of claim 16, wherein, when a second item is selected, the controller is further configured to:
contract the execution screen of the first item, and
change a display position of the contracted execution screen of the first item.

20. The electronic device of claim 13, wherein, when receiving a signal for downloading a first item, the controller is further configured to:
identify a category of the first item,
generate an item group corresponding to the identified category, and
store the first item in the generated item group.
